(19) United States
(12) Patent Application Publication
(10) Pub. No.: US 2021/0178714 A1
(43) Pub. Date: Jun. 17, 2021

(54) FORMING DEVICE FOR GREEN TIRE

(71) Applicant: TOYO TIRE CORPORATION, Itami-shi (JP)

(72) Inventor: Masaya Miyake, Itami-shi (JP)

(73) Assignee: TOYO TIRE CORPORATION, Itami-shi (JP)

(21) Appl. No.: 17/116,004

(22) Filed: Dec. 9, 2020

(30) Foreign Application Priority Data
Dec. 13, 2019 (JP) 2019-225706

(51) Int. Cl. B29D 30/24; B29D 30/30

(52) U.S. Cl. CPC B29D 30/242; B29D 30/3042

(57) ABSTRACT

A forming device forms a green tire including a discontinuous carcass ply composed of a pair of ply pieces. The forming device includes one servicer that sends out a strip-shaped first sheet for forming a plurality of the ply pieces, a drum around which the first sheet from the servicer is wound, a first cutting portion that cuts the first sheet to separate one of the ply pieces, a moving mechanism that relatively moves the servicer and the drum in the axial direction of the drum, and a control unit that controls the moving mechanism.

### CROSS-REFERENCE TO RELATED APPLICATIONS

This application claims priority of Japanese Patent Application No.: 2019-225706 filed on Dec. 13, 2019, the content of which is incorporated herein by reference.

### BACKGROUND OF THE INVENTION

### Technical Field

The present invention relates to a forming device for a green tire.

### Related Art

A pneumatic tire disclosed in JP 2017-109517 A discontinuous carcass ply positioned on the inner side in the tire radial direction of a tread portion. The carcass ply includes a pair of ply pieces extending from the tread portion to one of a pair of bead portions. In the center of the tread portion, a region where neither of the two ply pieces exists, that is, a hollow portion is provided.

### SUMMARY

The pneumatic tire of JP 2017-109517 A is completed by vulcanizing a green tire formed by winding a plurality of tire components including a pair of ply pieces around a forming drum. A forming device for this green tire requires two servicers, each of which supplies a pair of ply pieces. However, JP 2017-109517 A does not consider at all the reduction of the installation space.

An object of the present invention is to reduce the installation space of the forming device for a green tire including a carcass ply having a hollow portion.

One aspect of the present invention provides a forming device for a green tire including a discontinuous carcass ply, the discontinuous carcass ply including a pair of ply pieces having an inner end portion positioned on an inner side in a tire radial direction of a tread portion and a side portion extending to an inner side in the tire radial direction from the inner end portion and positioned on an inner side in a tire width direction of a sidewall portion. The forming device includes a first servicer that sends out a strip-shaped first sheet for forming a plurality of the ply pieces, a drum around which the first sheet from the first servicer is wound, a first cutting portion that cuts the first sheet in order to separate one of the ply pieces, a moving mechanism for relatively moving the first servicer and the drum in an axial direction of the drum, and a control unit that controls the moving mechanism so that the first servicer and the drum are relatively moved to a first position for forming one of the pair of ply pieces and a second position for forming the other one of the pair of ply pieces in this order.

In the present aspect, a pair of ply pieces can be formed with a first servicer by relatively moving the first servicer and the drum in the axial direction of the drum by the moving mechanism. That is, in the forming device which normally requires two servicers, only one servicer needs to be installed. Therefore, as compared with the case where two servicers are disposed, the installation space of the forming device for the green tire including the carcass ply having a hollow portion can be reduced.

Each of a pair of the ply pieces is formed from a first sheet (cloth). Since there is substantially no width variation in a first sheet, the rubber volume on both sides in the tire width direction of the green tire can be made uniform. Further, since one and the other one of a pair of the ply pieces are wound separately, the rotation angle position of the start end to be wound around the drum can be easily adjusted. The start end and the termination of the ply piece are overlapping regions, and these regions can be disposed at different positions in the tire circumferential direction. Accordingly, the uniformity of the completed pneumatic tire can be improved.

The moving mechanism moves only the drum.

In the present aspect, the moving mechanism of the existing forming facility for forming a green tire by winding the tire components around the drum that has been moved sequentially can be used. Therefore, by modifying the existing forming facility, it is possible to easily realize the forming device that forms a pair of the ply pieces with one servicer.

The green tire includes a ply that extends to the inner end portion of each of the pair of ply pieces, and has a central portion positioned on an inner side in a tire radial direction of the inner end portion and a pair of side portions extending from both ends of the central portion to an inner side in the tire radial direction. The forming device includes a second servicer, which is disposed adjacent to the first servicer in an axial direction of the drum and sends out a strip-shaped second sheet for forming a plurality of the plies, and a second cutting portion that cuts the second sheet in order to separate one of the plies. The control unit controls the moving mechanism so that the first servicer, the second servicer, and the drum relatively move to the first position from a third position for forming the ply.

When viewed from an axial direction of the drum, the control unit makes a rotation angle position of a start end of the first sheet wound around the drum different between one and the other one of the pair of ply pieces.

In the present aspect, it is possible to prevent the overlap regions, in which the rubber volume is locally increased, from concentrating on a part in the circumferential direction, so that the uniformity of the completed pneumatic tire can be improved.

a third servicer, which is disposed adjacent to the first servicer in an axial direction of the drum and sends out a strip-shaped third sheet for forming a plurality of the ply pieces, and a third cutting portion that cuts the third sheet in order to separate one of the ply pieces are included. The first sheet and the third sheet differ in at least one of a width, a rubber material, and the number of cords.

In the present aspect, since the sheets of different types can be disposed in one forming device, the time required for switching a production line can be shortened when pneumatic tires with carcass plies of different types is manufactured.

In the present invention, the installation space of a forming device for a green tire including a carcass ply having a hollow portion can be reduced.

### BRIEF DESCRIPTION OF THE DRAWINGS

The foregoing and the other features of the present invention will become apparent from the following description and drawings of an illustrative embodiment of the invention in which:

FIG. 1 is a perspective view showing a forming device for a green tire according to a first embodiment of the present invention;

FIG. 2 is a side view of the forming device of FIG. 1;

FIG. 3 is a plan view of a forming drum;

FIG. 4 is a block diagram of the forming device of FIG. 1;

FIG. 5A is a plan view showing a state in which a first ply is formed;

FIG. 5B is a perspective view showing a state in which the first ply is formed;

FIG. 6A is a plan view showing a state in which one of a pair of ply pieces is formed;

FIG. 6B is a perspective view showing a state in which one of a pair of the ply pieces is formed;

FIG. 7A is a plan view showing a state in which the other one of a pair of the ply pieces is formed;

FIG. 7B is a perspective view showing a state in which the other one of a pair of the ply pieces is formed;

FIG. 8 is a cross-sectional view showing a state in which the first ply and a pair of the ply pieces are wound;

FIG. 9 is a flowchart showing control by a control device;

FIG. 10 is a plan view of a forming device for a green tire according to a second embodiment;

FIG. 11 is a meridian cross-sectional view of a green tire; and

FIG. 12 is a cross-sectional view of a tread portion of a green tire and its surroundings.

### DETAILED DESCRIPTION OF EMBODIMENTS

Hereinafter, an embodiment of the present invention will be described with reference to the drawings.

(First Embodiment)

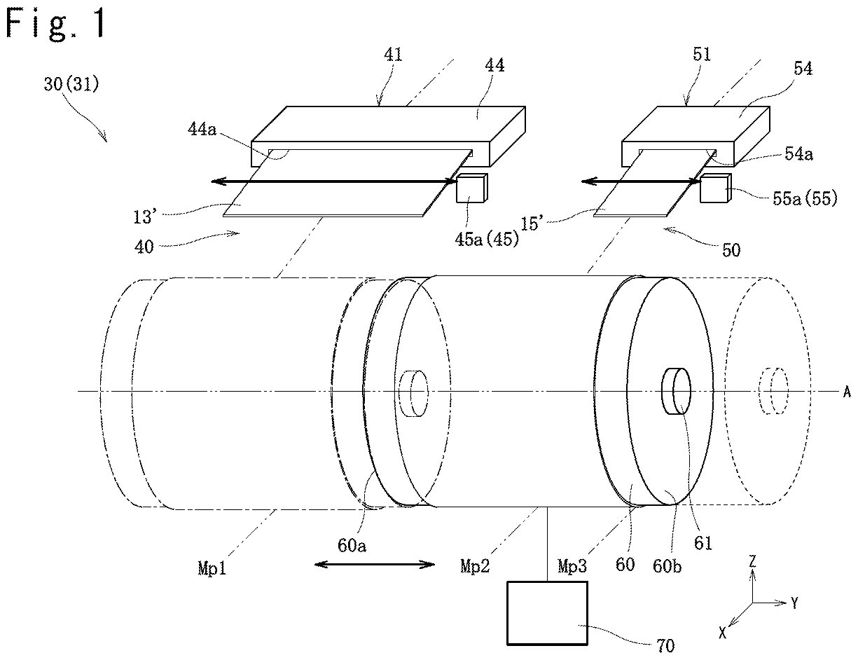

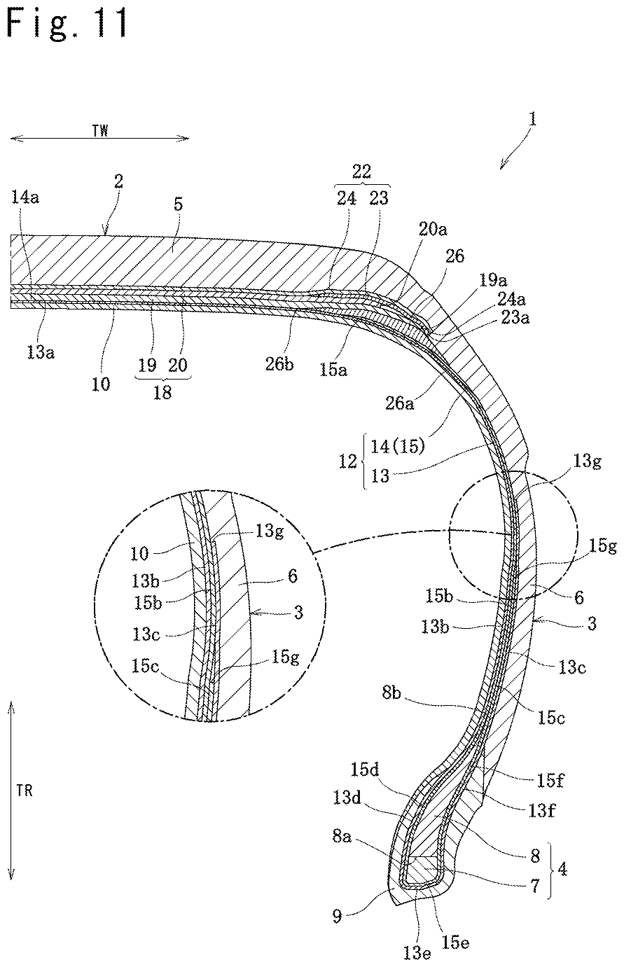

FIG. 1 shows a ply forming unit 31 in a forming device 30 of a green tire 1 according to a first embodiment of the present invention. A forming facility including the forming device 30 assembles a plurality of tire components in a cylindrical shape to form the cylindrical green tire 1 shown in FIG. 11. By vulcanizing the green tire 1 with a vulcanization device (not shown), a pneumatic tire made from rubber is completed.

First, a configuration of the green tire 1 will be specifically described.

As shown in FIG. 11, the green tire 1 includes a tread portion 2, a pair of sidewall portions 3, and a pair of ring-shaped bead portions 4.

The tread portion 2 includes tread rubber 5 extending in the tire width direction (indicated by the reference numeral TW in FIG. 11). The pneumatic tire completed by vulcanization is provided with a groove on the surface of the tread portion 2, that is, the tread surface.

Each of a pair of the sidewall portions 3 includes side rubber 6 extending from both ends of the tread portion 2 to the inner side in the tire radial direction (reference numeral TR in FIG. 11).

A pair of the bead portions 4 are disposed in end portions on the inner side in the tire radial direction of a pair of the sidewall portions 3. Each of the bead portions 4 includes a bead core 7 and a bead filler 8. The bead core 7 includes a large number of steel wires bundled in a ring shape. The bead filler 8 has a ring shape and is made from rubber that is harder than rubber that constitutes the tread portion 2 and the sidewall portion 3. The bead filler 8 includes a base end 8a disposed adjacent to the outer side in the tire radial direction of the bead core 7 and a tip end 8b on the side opposite to the base end 8a, and extends in a tapered shape from the base end 8a to the outer side in the tire radial direction toward the tip end 8b. Each of the bead portions 4 includes strip rubber 9 provided to wrap the bead core 7 and the bead filler 8.

The green tire 1 includes a carcass 12 hung in a toroidal shape between the bead portions 4. In the present embodiment, the carcass 12 includes a first carcass ply (hereinafter, referred to as “first ply”) 11 and a second carcass ply (hereinafter, referred to as “second ply”) 12. The second ply 14 is a ply having a hollow portion 14a, while the first ply 13 is a normal ply having no hollow portion. The first ply 11 and the second ply 12 will be described in detail later. An inner liner 10 is provided on the inner side of the carcass 12, that is, on the innermost peripheral surface of the green tire 1.

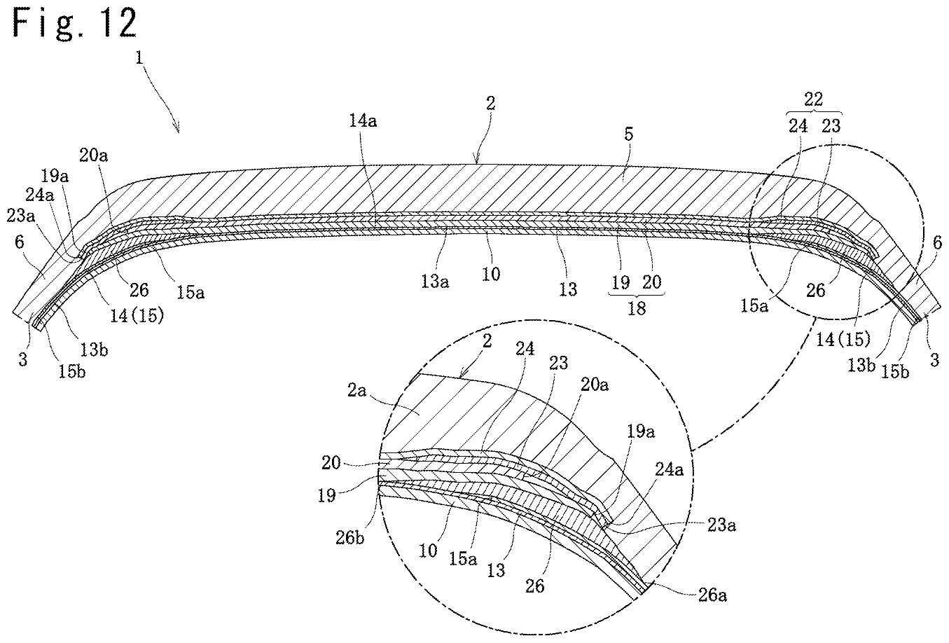

Referring to FIG. 12, an endless belt layer 18 is provided between the tread rubber 5 and the carcass 12. In the present embodiment, the belt layer 18 includes two belts 19 and 20. The belt 19 is disposed adjacent to the outer side in the tire radial direction of the carcass 12, and the belt 20 is disposed adjacent to the outer side in the tire radial direction of the belt 19. Further, in the present embodiment, the dimension in the tire width direction of the belt 19 in the lower layer is larger than the dimension in the tire width direction of the belt 20 in the upper layer, and an end portion 19a of the belt 19 is positioned closer to the outer side in the tire width direction than an end portion 20a of the belt 20. The belt layer 18 may be composed of one belt, or may include three or more belts.

An endless cap layer 22 is provided adjacent to the outer side in the tire radial direction of the belt layer 18. The cap layer 22 of the present embodiment includes a pair of narrow edge plies 23 that directly cover either of the end portions 19a and 20a of the belts 19 and 20. Further, the cap layer 22 of the present embodiment is disposed adjacent to the outer side in the tire radial direction of the edge ply 23, and includes a wide cap ply 24 as a single sheet that covers the entire belts 19 and 20 including the end portions 19a and 20a. The cap layer 22 may include one or three or more plies. Further, the cap layer 22 may be eliminated.

A pair of endless pads 26 made from rubber are disposed between both ends on the outer side in the tire width direction of the belt layer 18 and the carcass 12. The cross-sectional shape of the pad 26 is a flat triangular shape. The positions in the tire width direction of the end portions 19a and 20a of the belts 19 and 20, the end portion 23a on the outer side in the tire width direction of the edge ply 23, and an end portion 24a of the cap ply 24 are set in a region between an end portion 26a on the outer side in the tire width direction of the pad 26 and an end portion 26b on the inner side, that is, a region where the pad 26 exists. The pad 26 may be eliminated.

Hereinafter, the first ply 13 and the second ply 14 constituting the carcass 12 will be described.

Referring to FIGS. 11 and 12, the first ply 13 is a single ply, while the second ply 14 is a discontinuous ply having the hollow portion 14a as described above. The second ply 14 is composed of a pair of ply pieces 15.

The first ply 13 includes a central portion 13a positioned on the inner side in the tire radial direction of the tread portion 2, and a pair of side portions 13b extending from both ends in the tire width direction of the central portion 13a to the inner side in the tire radial direction. Further, the first ply 13 is provided continuously with the side portion 13b, and includes a wind-up portion 13c wound up from the inner side to the outer side in the tire width direction with respect to the bead core 7.

The central portion 13a extends from one to the other of inner end portions 15a of each of a pair of the ply pieces 15. More specifically, the range between the centers in the tire width direction of a pair of the pads 26 is the central portion 13a.

The side portion 13b is disposed adjacent to the outer side in the tire width direction of the inner liner 10.

The wind-up portion 13c is terminated in the sidewall portion 3. More specifically, the wind-up portion 13c includes an inner portion 13d, a winding portion 13e, and an outer portion 13f.

The inner portion 13d is disposed closer to the inner side in the tire radial direction than the bead portion 4, that is, the bead core 7 and the bead filler 8, with the ply piece 15 interposed between them.

The winding portion 13e is provided continuously with the inner portion 13d, and is wound around the bead core 7 with the ply piece 15 interposed between them.

The outer portion 13f is provided continuously with the winding portion 13e, and is disposed closer to the outer side in the tire radial direction than the bead portion 4 with the ply piece 15 interposed between them. An end portion of the outer portion 13f constitutes an end portion 13g of the first ply 13. The end portion 13g is positioned closer to the outer side in the tire radial direction than the tip end 8b of the bead filler 8 and is positioned closer to the inner side in the tire radial direction than the tread portion 2.

The second ply 14 is disposed adjacent to the outer side in the tire radial direction of the first ply 13, and is a discontinuous ply composed of a pair of the ply pieces 15. The ply piece 15 has the inner end portion 15a disposed between the belt layer 18 and the central portion 13a of the first ply 13. The pad 26 is interposed between the inner end portion 15a and the belt layer 18. The position in the tire width direction of the inner end portion 15a of the ply piece 15 is set in the region on the outer side in the tire width direction of the tread portion 2, more specifically, in the region closer to the inner side in the tire width direction to both the end portions 19a and 20a of the belts 19 and 20 constituting the belt layer 18. The hollow portion 14a is provided in the region at the center in the tire width direction of the tread portion 2, more specifically, in the region between the inner end portions 15a of a pair of the ply pieces 15. In the hollow portion 14a, the second ply 14 does not exist, and only the central portion 13a of the first ply 13 exists.

The ply piece 15 includes a side portion 15b extending to the inner side in the tire radial direction from the inner end portion 15a, and a wind-up portion 15c wound up from the inner side to the outer side in the tire width direction with respect to the bead core 7.

The side portion 15b is disposed adjacent to the outer side in the tire width direction of the side portion 13b of the first ply 13.

The wind-up portion 15c is provided continuously with the side portion 15b and is terminated in the sidewall portion 3. The wind-up portion 15c includes an inner portion 15d, a winding portion 15e, and an outer portion 15f.

The inner portion 15d is disposed on the inner side in the tire radial direction of the bead portion 4, more specifically, between the bead portion 4 and the inner portion 13d of the first ply 13.

The winding portion 15e is provided continuously with the inner portion 15d and is wound around the bead core 7. More specifically, the winding portion 15e is disposed between the bead core 7 and the winding portion 13e of the first ply 13.

The outer portion 15f is provided continuously with the winding portion 15e, and is disposed closer to the outer side in the tire radial direction than the bead portion 4. Of the outer portion 15f, a part positioned on the inner side in the tire radial direction is disposed so as to overlap the outer side in the tire radial direction of the bead portion 4, and the rest is disposed so as to overlap the outer side in the tire radial direction of the side portion 15b. An end portion of the outer portion 15f constitutes an outer end portion 15g of the ply piece 15. The outer end portion 15g is positioned closer to the outer side in the tire radial direction than the tip end 8b of the bead filler 8 and is positioned closer to the inner side in the tire radial direction than the tread portion 2, more specifically, the end portion 13g of the first ply 13.

The first ply 13, the ply piece 15 of the second ply 14, the belts 19 and 20, and the plies 23 are 24 are all composed of a strip-shaped sheet in which a plurality of cords arranged side by side at intervals are covered with rubber. Other components than these and the bead core 7, that is, the tread rubber 5, the side rubber 6, the bead filler 8, the strip rubber 9, the inner liner 10, and the pad 26 are made from a rubber member.

The green tire 1 configured as described above is formed as described below.

First, the inner liner 10, the strip rubber 9, the first ply 13, and a pair of the ply pieces 15 are laminated in this order to form a cylindrical carcass band. Subsequently, the carcass band is subjected to a step including bead setting and turn-up to form a cylindrical green case. Separately from the carcass band, the pad 26, the belts 19 and 20, the plies 23 and 24, and the tread rubber 5 are laminated in this order to form a cylindrical tread band. After that, the green case disposed in the tread band is bulged to the outer side in the radial direction, and the carcass band is assembled with an inner peripheral portion of the tread band.

That is, forming of the green tire 1 includes a first forming step for forming the carcass band, a second forming step for forming the green case, a third forming step for forming the tread band, and a fourth forming step for assembling the green case and the tread band. A forming facility for the green tire 1 includes forming devices corresponding to the first forming step to the fourth forming step.

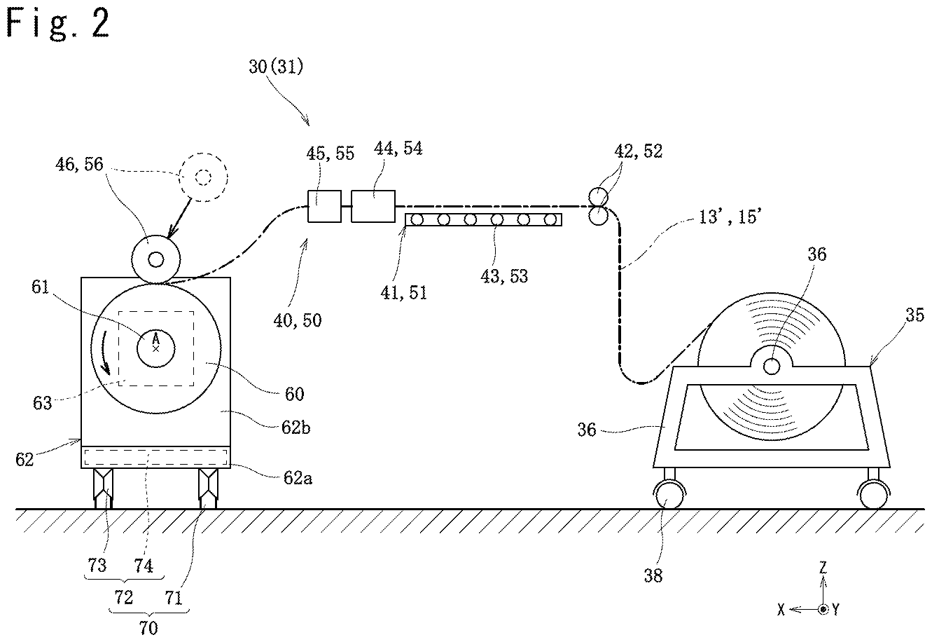

FIGS. 1 and 2 show the ply forming unit 31 of the first forming device 30 that performs the first forming step. The other configurations of the first forming device 30, that is, the configuration of the forming unit for forming the inner liner 10 and the strip rubber 9 is similar to the conventional one. Further, the configurations of components other than the first forming device 30 are also similar to those in the conventional ones.

As shown in FIGS. 1 and 2, the ply forming unit 31 of the forming device 30 includes a first forming unit 40 for forming the first ply 13 and a second forming unit 50 for forming a pair of the ply pieces 15. Further, the forming device 30 includes one forming drum 60 and a moving mechanism 70 for moving the forming drum 60. The forming drum 60 wound with the inner liner 10 and the strip rubber 9 is moved to the first forming unit 40 and the second forming unit 50 in this order, and the first ply 13 and the second ply 14 are sequentially formed on the outer circumference of the forming drum 60.

The first forming unit 40 and the second forming unit 50 have similar configurations, and are disposed adjacent to each other in the Y direction (axial direction) in which an axis A of the forming drum 60 extends. Specifically, the first forming unit 40 includes one servicer (second servicer) 41 for sending out a strip-shaped first ply sheet (second sheet) 13′ for forming a plurality of the first plies 13. The second forming unit 50 includes one servicer (first servicer) 51 for sending out a strip-shaped ply piece sheet (first sheet) 15′ for forming a plurality of the ply pieces 15.

That is, there is only one servicer 51 that forms a pair of the ply pieces 15, and the servicer 51 forms one and the other one of a pair of the ply pieces 15 in order. In the description below, of a pair of the ply pieces 15, the one positioned on the right side in FIG. 12 may be referred to as a first ply piece 15, and the one positioned on the left side in FIG. 12 may be referred to as a second ply piece 15.

As most clearly shown in FIG. 2, the first ply sheet 13′ and the ply piece sheet 15′ are wound around the same type of carriages 35 and set on the servicers 41 and 51, respectively. The width of the first ply sheet 13′ in the Y direction corresponds to the width of the first ply 13 from one of a pair of the end portions 13g to the other. The width of the ply piece sheet 15′ in the Y direction corresponds to the width of the ply piece 15 from the inner end portion 15a to the outer end portion 15g. The width of the ply piece sheet 15′ is smaller than the width of the first ply sheet 13′. By winding the ply piece sheet 15′ on the carriage 35 having a size capable of winding the first ply sheet 13′, the number of parts required for the forming facility is reduced.

The carriage 35 includes a winding shaft 36 having a total length capable of winding the first ply sheet 13′, a frame body 36 having a size surrounding the wound first ply sheet 13′, and a moving roller 38 attached to a lower part of the frame body 36. The winding shaft 36 is rotatable with respect to the frame body 36.

The servicer 41 of the first ply sheet 13′ and the servicer 51 of the ply piece sheet 15′ have substantially the same configurations and are disposed adjacent to each other in the Y direction. The servicer 41 of the first ply sheet 13′ includes a pair of unwinding rollers 42, a conveyor 43, a guide 44, a cutting device (second cutting portion) 45, and a holding roller 46. The servicer 51 of the ply piece sheet 15′ includes a pair of unwinding rollers 52, a conveyor 53, a guide 54, a cutting device (first cutting portion) 55, and a holding roller 56. All of these are disposed above the top of the forming drum 60, and supply the first ply sheet 13′ and the ply piece sheet 15′ to the forming drum 60 from above.

The servicers 41 and 51 differ in that the widths in the Y direction along the axis A of the forming drum 60 are different. Specifically, the width of the servicer 51 of the first ply sheet 13′ is smaller than the width of the servicer 41 of the ply piece sheet 15′. The width of the servicer 41 corresponds to the width of the first ply sheet 13′, and the width of the servicer 51 corresponds to the width of the ply piece sheet 15′.

Each of the unwinding rollers 42 and 52 are rotated by an electric motor (not shown). Of a pair of the unwinding rollers 42 and a pair of the unwinding rollers 52, the one positioned on the upper side rotates clockwise in FIG. 2, and the one positioned on the lower side rotates counterclockwise in FIG. 2. The first ply sheet 13′ wound around the carriage 35 is unwound by the drive of the unwinding roller 42 of the first forming unit 40. The ply piece sheet 15′ wound around the carriage 35 is unwound by the drive of the unwinding roller 52 of the second forming unit 50.

The conveyors 43 and 53 are disposed between the unwinding rollers 42 and 52 and the forming drum 60. Each of the conveyors 43 and 53 is composed of a roller conveyor including a plurality of rollers disposed at intervals in the unwinding direction (X direction) of the sheets 13′ and 15′. The individual rollers extend in the width direction (Y direction) of the sheets 13′ and 15′.

The guides 44 and 54 are disposed between the conveyor 43 and the forming drum 60. As most clearly shown in FIG. 1, the guide 44 of the first forming unit 40 is a square tubular frame body that determines the position where the first ply sheet 13′ is sent out, and includes an unwinding port 44a having a size through which the first ply sheet 13′ can be unwound. The guide 54 of the second forming unit 50 is a square tubular frame body that determines the position where the ply piece sheet 15′ is sent out, and includes an unwinding port 54a having a size through which the ply piece sheet 15′ can be unwound.

The cutting devices 45 and 55 are disposed between the guides 44 and 54 and the forming drum 60. Referring to FIG. 1, the cutting device (second cutting portion) 45 of the first forming unit 40 includes a cutter 45a capable of advancing and retreating in the width direction (Y direction) of the first ply sheet 13′, and separates a first ply 13 from the first ply sheet 13′ by moving the cutter 45a. The cutting device (first cutting portion) 55 of the second forming unit 50 includes a cutter 55a capable of advancing and retreating in the width direction (Y direction) of the ply piece sheet 15′, and separates one ply piece 15 from the ply piece sheet 15′ by moving the cutter 55a.

The holding rollers 46 and 56 are disposed between the cutting devices 45 and 55 and the forming drum 60. Each of the holding rollers 46 and 56 is made from an elastic body such as sponge, and can be moved to an advance position in contact with the top of the forming drum 60 and a retracted position away from the forming drum 60 by an actuator (not shown).

The forming drum 60 is a cylindrical body that can be expanded and contracted around a rotating shaft 61. The total length of the forming drum 60 from a base end 60a to a tip end 60b is larger than the width of the widest first ply sheet 13′ among the tire components wound around the forming drum 60.

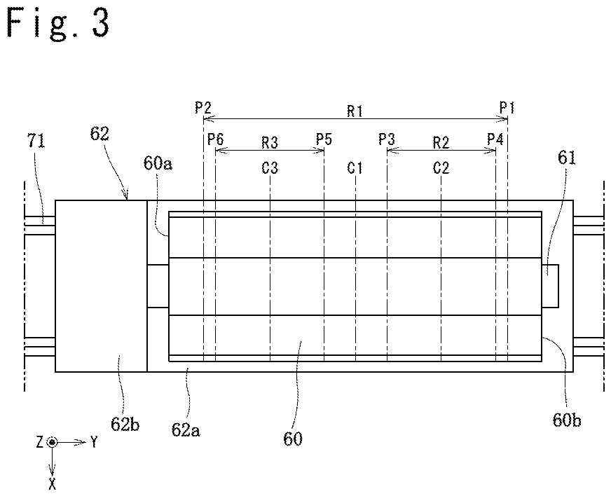

Referring to FIGS. 2 and 3, the forming drum 60 is rotatably attached to a support base 62. The support base 62 includes a base portion 62a extending along the XY plane and a support portion 62b rising from one end of the base portion 62a along the XZ plane. An electric motor 63 is disposed inside the support portion 62b. The rotating shaft 61 is rotated counterclockwise in FIG. 2 by the drive of the electric motor 63, so that the forming drum 60 is integrally rotated.

As shown most clearly in FIG. 3, in the forming drum 60, a region between positions P1 and P2 is a first forming region R1 (third region) for forming the first ply 13. In the forming drum 60, a region between positions P3 and P4 is a second forming region R2 (first region) for forming the first ply piece 15. In the forming drum 60, a region between positions P5 and P6 is a third forming region R3 (second region) for forming the second ply piece 15. In the forming drum 60, a region between positions P3 and P5 is a region where the hollow portion 14a is formed.

One of a pair of the end portions 13g of the first ply 13 is located at the position P1, and the other one of a pair of the end portions 13g of the first ply 13 is located at the position P2. The inner end portion 15a of the first ply piece 15 is located at the position P3, and the outer end portion 15g of the first ply piece 15 is located at the position P4. The inner end portion 15a of the second ply piece 15 is located at the position P5, and the outer end portion 15g of the second ply piece 15 is located at the position P6.

Referring to FIGS. 1 and 2, the moving mechanism 70 relatively moves the servicer 41 and the forming drum 60 for the first ply sheet 13′, and relatively moves the servicer 51 and the forming drum 60 for the ply piece sheet 15′. In the present embodiment, the servicers 41 and 51 of the forming units 40 and 50 are fixed at fixed positions, and the moving mechanism 70 moves only the forming drum 60 in the axial direction (Y direction) of the forming drum 60.

The moving mechanism 70 includes a conveyance path 71 that is laid to extend in the Y direction in which the first forming unit 40 and the second forming unit 50 are adjacent to each other, and a drive unit 72 that moves the forming drum 60 along the conveyance path 71. In the present embodiment, the conveyance path 71 is composed of a pair of rails that are adjacent to the forming units 40 and 50 in the X direction and extend in parallel in the Y direction. The drive unit 72 includes four wheels 73 disposed at the bottom of the base portion 62a and an electric motor 74 disposed inside the base portion 62a. When the electric motor 74 rotates in the normal direction, the wheel 73 rotates in the normal direction, and the forming drum 60 moves to the right side in FIG. 1 integrally with the support base 62. When the electric motor 74 is reversed, the wheel 73 is reversed, and the forming drum 60 moves to the left side in FIG. 1 integrally with the support base 62.

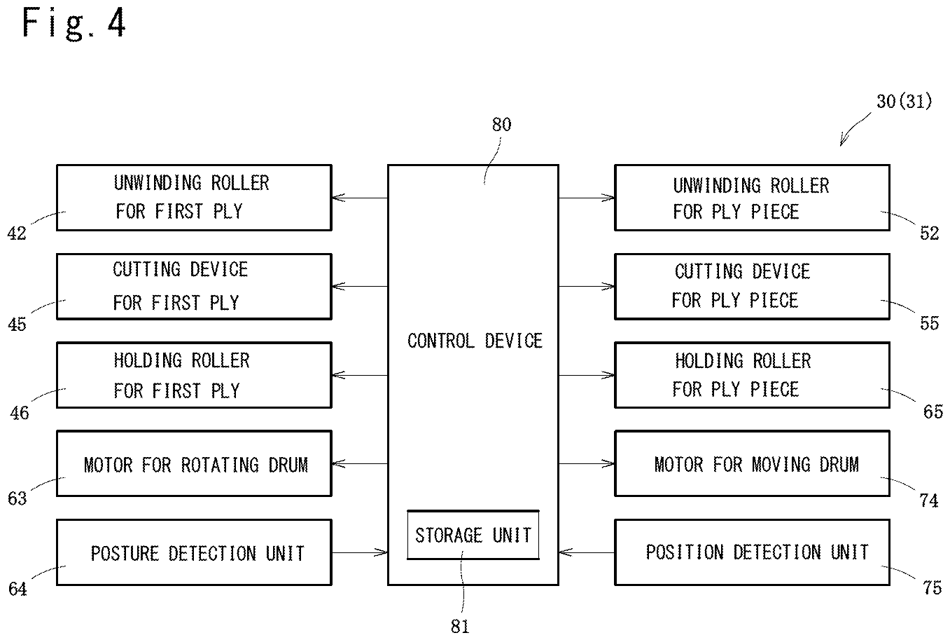

The first forming unit 40, the second forming unit 50, the forming drum 60, and the moving mechanism 70 are controlled by a control device (control unit) 80. Specifically, as shown in FIG. 4, the control device 80 is electrically connected to the unwinding rollers 42 and 52, the cutting devices 45 and 55, the holding rollers 46 and 56, the electric motor 63 for rotating the forming drum 60, and the electric motor 74 for moving the forming drum 60.

The control device 80 is composed of a well-known computer including a CPU, a memory, a storage device, and an input/output device, and software implemented in the computer. A storage unit 81 stores reference data of all the tire components wound around the forming drum 60. The reference data includes the position in the drum axial direction (forming positions Mp1 to Mp3) at which the sheets 13′ and 15′ are wound around the forming drum 60, total lengths of the first ply 13 and the ply piece 15 corresponding to the length in the drum circumferential direction, and the like.

The control device 80 controls the moving mechanism 70 based on a detection result of a position detection unit 75 that detects the position of the forming drum 60, and disposes the forming drum 60 at the predetermined forming positions Mp1 to Mp3. For the position detection unit 75, a system including a transmission unit that wirelessly transmits signals of indoor messaging system (IMES) positioning, Wi-Fi positioning, beacon positioning, and the like and a positioning unit that measures a position based on a received signal can be used. However, the position detection unit 75 can be changed as necessary as long as the unit has a configuration that can detect the position of the forming drum 60.

Specifically, the storage unit 81 stores position information of the first forming position Mp1 (third position) for forming the first ply 13, the second forming position Mp2 (first position) for forming the first ply piece 15, and the third forming position Mp3 (second position) for forming the second ply piece 15.

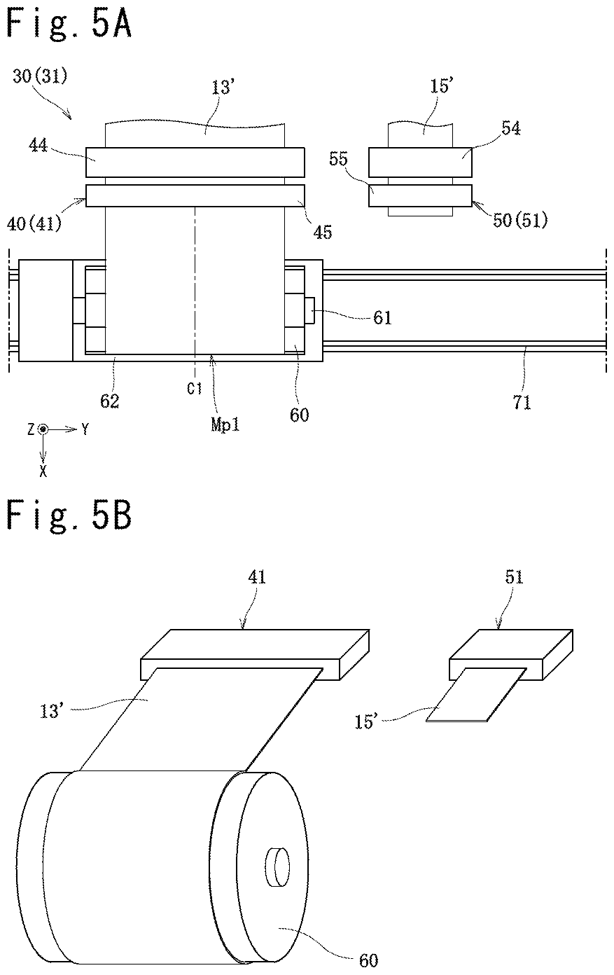

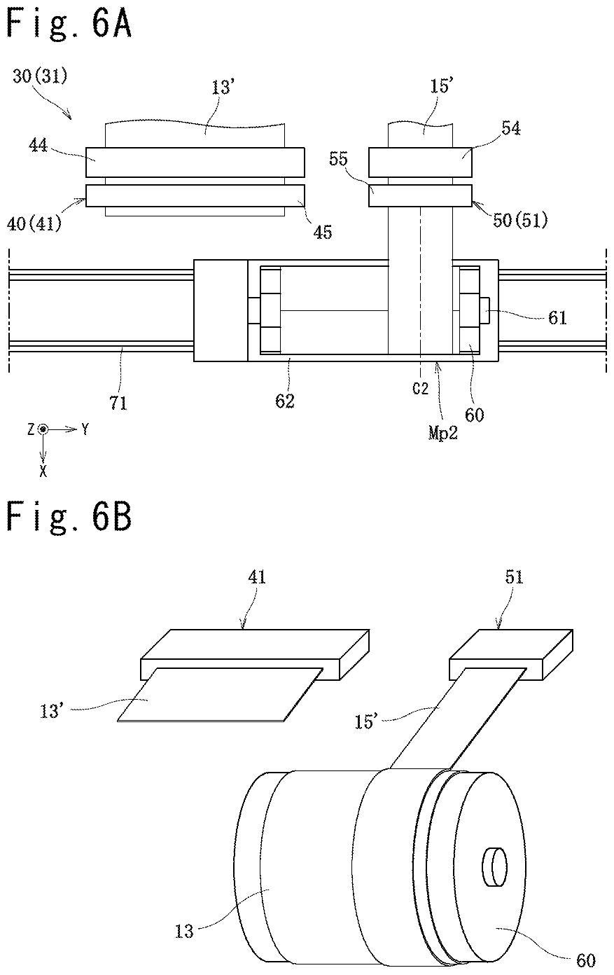

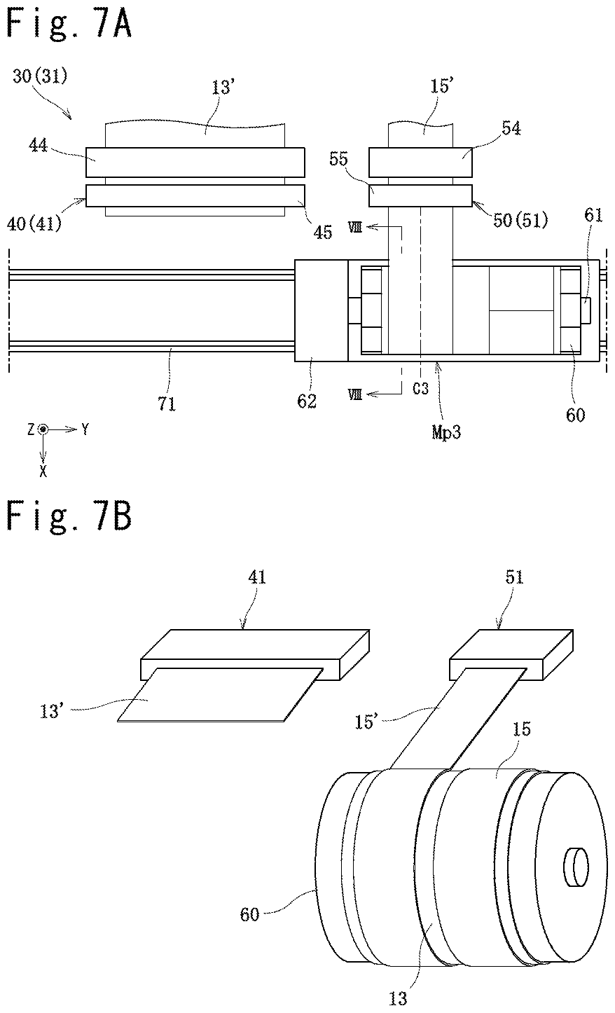

As shown by the alternate long and short dash line in FIG. 1 and FIGS. 5A and 5B, the first forming position Mp1 is a position where the center C1 of the first forming region R1 of the forming drum 60 and the center of the guide 44 of the first forming unit 40 face each other in the Y direction. As shown by the solid line in FIG. 1 and FIGS. 6A and 6B, the second forming position Mp2 is a position where the center C2 of the second forming region R2 of the forming drum 60 and the center of the guide 54 of the second forming unit 50 face each other in the Y direction. As shown by the broken line in FIG. 1 and FIGS. 7A and 7B, the third forming position Mp3 is a position where the center C3 of the third forming region R3 of the forming drum 60 and the center of the guide 54 of the second forming unit 50 face each other in the Y direction.

The control device 80 moves the forming drum 60 by the moving mechanism 70 in the order of the first forming position Mp1, the second forming position Mp2, and the third forming position Mp3 based on the position information stored in the storage unit 81 and the detection result of the position detection unit 75. That is, the forming drum 60 is moved by the moving mechanism 70 so that the position information of the first forming position Mp1 and the detection result of the position detection unit 75 match each other. Subsequently, the forming drum 60 is moved by the moving mechanism 70 so that the position information of the second forming position Mp2 and the detection result of the position detection unit 75 match each other. Subsequently, the forming drum 60 is moved by the moving mechanism 70 so that the position information of the third forming position Mp3 and the detection result of the position detection unit 75 match each other.

Further, the control device 80 controls the forming drum 60 based on a detection result of a posture detection unit 64 that detects the rotation angle position (posture) of the forming drum 60, and also controls the first forming unit 40 and the second forming unit 50 individually. For the posture detection unit 64, a detection mechanism or the like that detects a specific position of the rotating shaft 61 or the forming drum 60 itself by a limit switch can be used. However, the position detection unit 75 can be changed as necessary as long as the unit has a configuration that can detect the rotation angle position of the forming drum 60.

At the forming positions Mp1 to Mp3, the control device 80 controls the rotation of the forming drum 60 and the corresponding forming units 40 and 50 based on the detection result of the posture detection unit 64.

In a state where the forming drum 60 is located at the predetermined rotation angle position, the unwinding rollers 42 and 52 are rotated, and the holding rollers 46 and 56 at the retracted position are caused to advance. In this manner, tip ends (start ends 13h and 15h) of the sheets 13′ and 15′ are crimped to the forming drum 60 by the holding rollers 46 and 56. By rotating the forming drum 60 in this state, the sheets 13′ and 15′ are wound around the outer circumference of the forming drum 60.

Subsequently, when the forming drum 60 is rotated to a predetermined angle position, the cutting devices 45 and 55 are driven, and then rotation of the unwinding rollers 42 and 52 is stopped after the sheets 13′ and 15′ are cut. Further, when cutting edges (terminations 13i and 15i) pass through the holding rollers 46 and 56, the holding rollers 46 and 56 are retracted and the rotation of the forming drum 60 is stopped.

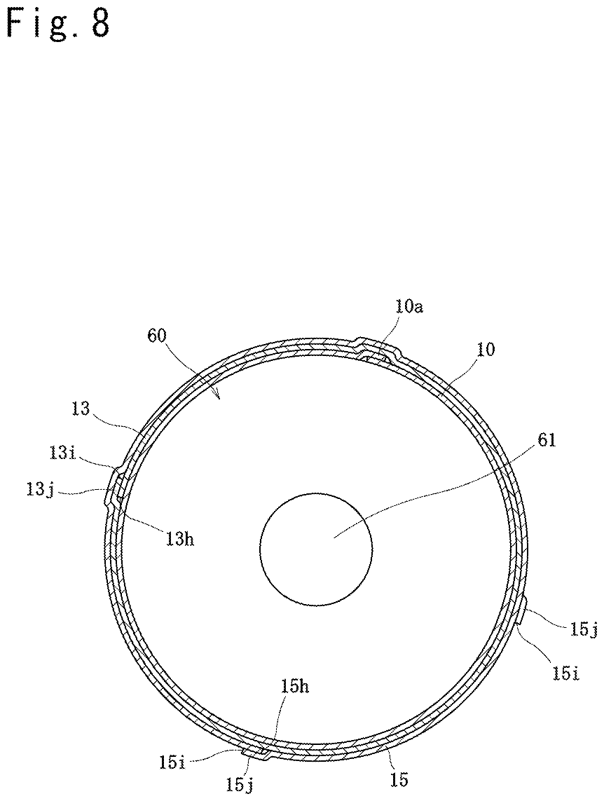

As shown in FIG. 8, the first ply 13 is formed in the first forming region R1 of the forming drum 60 in a state where a part on the start end 13h side and a part on the termination 13i side overlap each other. Further, the first ply piece 15 is formed in the second forming region R2 in a state where a part on the start end 15h side and a part on the termination 15i side overlap each other, and the second ply piece 15 is formed in the third forming region R3 in a state where a part on the start end 15h side and a part on the termination 15i side overlap each other.

Subsequently, referring to FIG. 8, when viewed from the axial direction of the forming drum 60, the control device 80 of the present embodiment makes the rotation angle position of the start end 15h of the ply piece sheet 15′ wound around the forming drum 60 different between one and the other one of a pair of the ply pieces 15. That is, between a pair of the ply pieces 15, overlap regions 15j of the start end 15h side and the termination 15i side are different in the tire circumferential direction. Further, these positions are different from an overlap region 10a of the inner liner 10 and an overlap region 13j of the first ply 13 in the tire circumferential direction.

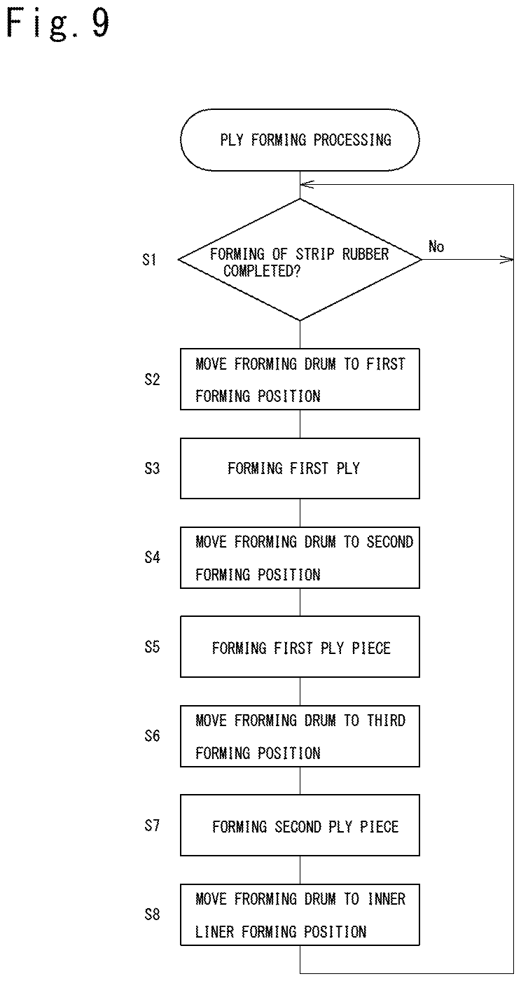

Next, an example of ply forming treatment by the control device 80 will be described with reference to FIG. 9.

As shown in FIG. 9, when the forming of the strip rubber 9 has been completed in Step S1, the control device 80 controls the moving mechanism 70 based on the detection result of the position detection unit 75 to move the forming drum 60 to the first forming position Mp1 in Step S2. Subsequently, in Step S3, the control device 80 controls the first forming unit 40 and the forming drum 60 based on the detection result of the posture detection unit 64, so that the first ply sheet 13′ (first ply 13) is wound around the forming drum 60.

When the forming of the first ply 13 has been completed, in Step S4, the control device 80 controls the moving mechanism 70 based on the detection result of the position detection unit 75 to move the forming drum 60 to the second forming position Mp2. Subsequently, in Step S5, the control device 80 controls the second forming unit 50 and the forming drum 60 based on the detection result of the posture detection unit 64, so that the ply piece sheet 15′ (first ply piece 15) is wound around the forming drum 60.

When the forming of the first ply piece 15 is completed, in Step S6, the control device 80 controls the moving mechanism 70 based on the detection result of the position detection unit 75 to move the forming drum 60 to the third forming position Mp3. Subsequently, in Step S7, the control device 80 controls the second forming unit 50 and the forming drum 60 based on the detection result of the posture detection unit 64, so that the ply piece sheet 15′ (second ply piece 15) is wound around the forming drum 60.

When the forming of the second ply piece 15 is completed, in Step S8, the control device 80 controls the moving mechanism 70 based on the detection result of the position detection unit 75 to move the forming drum 60 to the forming position of the inner liner 10, and the treatment returns to Step S1. However, the first ply piece 15 and the second ply piece 15 may be formed in the reverse order.

The forming device 30 of the present embodiment configured as described above has a feature described below.

The moving mechanism 70 that relatively moves the servicer 51 and the forming drum 60 to the second forming position Mp2 for forming one of a pair of the ply pieces 15 and the third forming position Mp3 for forming the other one of a pair of the ply pieces 15 is included. Therefore, a pair of the ply pieces 15 can be formed with one servicer 51. That is, in the forming device 30 which normally requires two servicers, only one servicer 51 needs to be installed. Therefore, as compared with the case where two servicers are disposed, the installation space of the forming device 30 for the green tire 1 including the second ply 14 having the hollow portion 14a can be reduced.

Each of a pair of the ply pieces 15 constituting the green tire 1 is formed by one ply piece sheet 15′ (cloth). Since there is substantially no width variation in one ply piece sheet 15′, the rubber volume on both sides in the tire width direction of the green tire 1 can be made uniform.

Further, since one and the other one of a pair of the ply pieces 15 are wound separately, the rotation angle position of the start end 15h to be wound around the forming drum 60 can be easily adjusted. That is, the overlap regions 15j of a pair of the ply pieces 15 can be disposed at different positions in the tire circumferential direction so that the overlap regions 15j are not concentrated on a part in the circumferential direction. Therefore, the uniformity of the completed pneumatic tire can be improved.

The moving mechanism 70 moves only the forming drum 60. In this case, the moving mechanism 70 of the existing forming facility for forming the green tire 1 by winding the tire components around the forming drum 60 that has been moved sequentially can be used. Therefore, by modifying the existing forming facility, it is possible to easily realize the forming device 30 that forms a pair of the ply pieces 15 with one servicer 51.

When viewed from the axial direction of the forming drum 60, the rotation angle position of the start end 15h of the ply piece sheet 15′ wound around the forming drum 60 is made different between one and the other one of a pair of the ply pieces 15. Therefore, it is possible to prevent the overlap regions 15j, in which the rubber volume is locally increased, from concentrating on a part in the circumferential direction, so that the uniformity of the completed pneumatic tire can be improved.

(Second Embodiment)

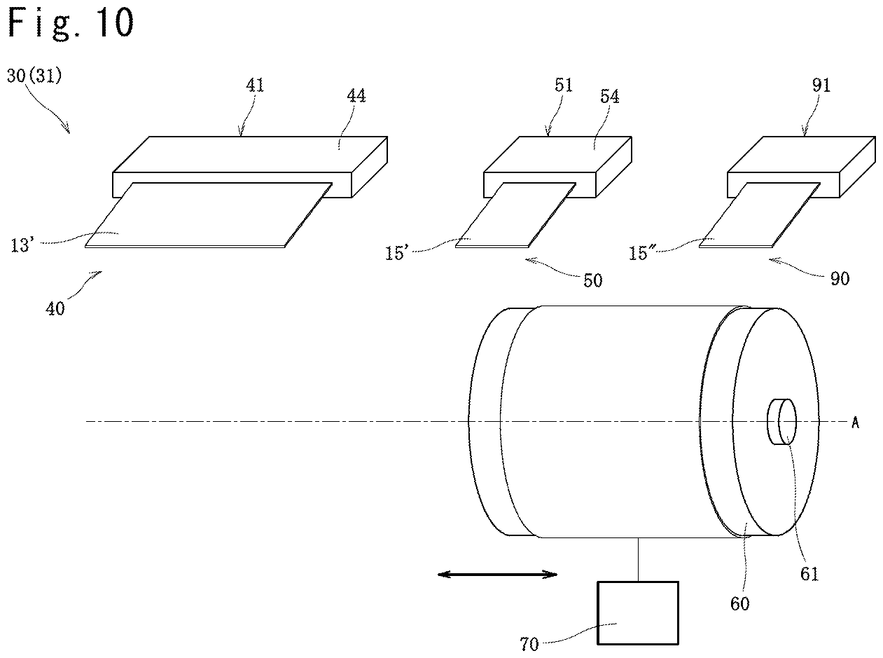

FIG. 10 shows the ply forming unit 31 of the forming device 30 of a second embodiment. This forming device 30 is different from the forming device 30 of the first embodiment in that a third forming unit 90 for forming the ply pieces 15 of different types is added.

The third forming unit 90 is disposed on the side opposite to the first forming unit 40 with respect to the second forming unit 50, and is adjacent to the second forming unit 50 in the Y direction. The third forming unit 90 includes one servicer (third servicer) 91 for sending out a strip-shaped ply piece sheet (third sheet) 15″ for forming a plurality of the ply pieces 15. The configuration of the servicer 91 is similar to that of the servicer 51 shown in FIG. 2. That is, the servicer 91 includes a pair of unwinding rollers, a conveyor, a guide, a cutting device (third cutting portion), and a holding roller.

The ply piece sheet 15″ which is different from the ply piece sheet 15′ set in the second forming unit 50 is set in the third forming unit 90. The ply piece sheet 15′ of the second forming unit 50 and the ply piece sheet 15″ of the third forming unit 90 differ in at least one of the width in the Y direction, the rubber material, and the number of cords. Therefore, the pneumatic tire including the ply piece 15 composed of the ply piece sheet 15′ and the pneumatic tire including the ply piece 15 composed of the ply piece sheet 15″, which have the same appearance and cross-sectional shape, have different rigidity (contributing to improvement in the steering stability) and cut resistance for the sidewall portion 3.

The control device 80 (see FIG. 4) of the second embodiment selectively drives only one of the second forming unit 50 and the third forming unit 90 according to the instruction of the operator. That is, in a case where the second forming unit 50 is selected, the third forming unit 90 is not driven. Further, in a case where the third forming unit 90 is selected, the second forming unit 50 is not driven. The control in a case where the third forming unit 90 is selected is the same as the control of the second forming unit 50. While one of the second forming unit 50 and the third forming unit 90 is used to manufacture the green tire 1, the operator can switch to use the other one to manufacture the green tire 1.

The forming device 30 of the second embodiment configured in this way can obtain an action and an effect similar to those of the first embodiment. Moreover, since the ply piece sheets 15′ and 15″ of different types can be disposed in one forming device 30, the time required for switching a production line can be shortened when pneumatic tires with the second plies 14 of different types is manufactured.

Note that the forming device 30 for the green tire 1 of the present invention is not limited to the configuration of the above embodiment, and various changes can be made.

For example, three or more forming units for the ply pieces 15 may be disposed in order to form the ply pieces 15 of different types.

The first forming unit 40 may be eliminated, and the carcass 12 of the green tire 1 may be formed only with the second ply 14 having the hollow portion 14a. In order to provide two or more of the second plies 14 having the hollow portion 14a, the forming drum 60 may be repeatedly moved to the second forming position Mp2 and the third forming position Mp3 by the moving mechanism 70.

The moving mechanism 70 may move the servicers 41 and 51 by fixing the forming drum 60 to a fixed position, or may move all of the servicers 41 and 51 and the forming drum 60. Further, the moving mechanism 70 can be changed as necessary as long as the moving mechanism 70 is configured to be able to relatively move the first forming unit 40, the second forming portion 50, and the forming drum 60.

What is claimed is:

1. A forming device for a green tire including a discontinuous carcass ply, the discontinuous carcass ply including a pair of ply pieces having an inner end portion positioned on an inner side in a tire radial direction of a tread portion and a side portion extending to an inner side in the tire radial direction from the inner end portion and positioned on an inner side in a tire width direction of a sidewall portion, the forming device comprising:
a first servicer that sends out a strip-shaped first sheet for forming a plurality of the ply pieces;
a drum around which the first sheet from the first servicer is wound;
a first cutting portion that cuts the first sheet in order to separate one of the ply pieces;
a moving mechanism for relatively moving the first servicer and the drum in an axial direction of the drum; and
a control unit that controls the moving mechanism so that the first servicer and the drum are relatively moved to a first position for forming one of the pair of ply pieces and a second position for forming the other one of the pair of ply pieces in this order.

2. The forming device for a green tire according to claim 1, wherein
at the first position, the first sheet is aligned in a width direction to a center of a first region in the drum where one of the pair of ply pieces is formed, and
at the second position, the first sheet is aligned in the width direction to a center of a second region in the drum where the other one of the pair of ply pieces is formed.

3. The forming device for a green tire according to claim 1, wherein
the moving mechanism moves only the drum.

4. The forming device for a green tire according to claim 2, wherein
the moving mechanism moves only the drum.

5. The forming device for a green tire according to claim 1, wherein
the green tire includes a ply that extends to the inner end portion of each of the pair of ply pieces, and has a central portion positioned on an inner side in a tire radial direction of the inner end portion and a pair of side portions extending from both ends of the central portion to an inner side in the tire radial direction,
the forming device comprising:
a second servicer, which is disposed adjacent to the first servicer in an axial direction of the drum and sends out a strip-shaped second sheet for forming a plurality of the plies; and
a second cutting portion that cuts the second sheet in order to separate one of the plies, wherein
the control unit controls the moving mechanism so that the first servicer, the second servicer, and the drum relatively move to the first position from a third position for forming the ply.

6. The forming device for a green tire according to claim 2, wherein
the green tire includes a ply that extends to the inner end portion of each of the pair of ply pieces, and has a central portion positioned on an inner side in a tire radial direction of the inner end portion and a pair of side portions extending from both ends of the central portion to an inner side in the tire radial direction,
the forming device comprising:
a second servicer, which is disposed adjacent to the first servicer in an axial direction of the drum and sends out a strip-shaped second sheet for forming a plurality of the plies; and
a second cutting portion that cuts the second sheet in order to separate one of the plies, wherein
the control unit controls the moving mechanism so that the first servicer, the second servicer, and the drum relatively move to the first position from a third position for forming the ply.

7. The forming device for a green tire according to claim 3, wherein
the green tire includes a ply that extends to the inner end portion of each of the pair of ply pieces, and has a central portion positioned on an inner side in a tire radial direction of the inner end portion and a pair of side portions extending from both ends of the central portion to an inner side in the tire radial direction,
the forming device comprising:
a second servicer, which is disposed adjacent to the first servicer in an axial direction of the drum and sends out a strip-shaped second sheet for forming a plurality of the plies; and
a second cutting portion that cuts the second sheet in order to separate one of the plies, wherein
the control unit controls the moving mechanism so that the first servicer, the second servicer, and the drum relatively move to the first position from a third position for forming the ply.

8. The forming device for a green tire according to claim 4, wherein
the green tire includes a ply that extends to the inner end portion of each of the pair of ply pieces, and has a central portion positioned on an inner side in a tire radial direction of the inner end portion and a pair of side portions extending from both ends of the central portion to an inner side in the tire radial direction,
the forming device comprising:
a second servicer, which is disposed adjacent to the first servicer in an axial direction of the drum and sends out a strip-shaped second sheet for forming a plurality of the plies; and
a second cutting portion that cuts the second sheet in order to separate one of the plies, wherein
the control unit controls the moving mechanism so that the first servicer, the second servicer, and the drum relatively move to the first position from a third position for forming the ply.

9. The forming device for a green tire according to claim 5, wherein
at the third position, the second sheet is aligned in the width direction to a center of a third region in the drum where the ply is formed.

10. The forming device for a green tire according to claim 6, wherein
at the third position, the second sheet is aligned in the width direction to a center of a third region in the drum where the ply is formed.

11. The forming device for a green tire according to claim 7, wherein
at the third position, the second sheet is aligned in the width direction to a center of a third region in the drum where the ply is formed.

12. The forming device for a green tire according to claim 8, wherein
at the third position, the second sheet is aligned in the width direction to a center of a third region in the drum where the ply is formed.

13. The forming device for a green tire according to claim 1, wherein
when viewed from an axial direction of the drum, the control unit makes a rotation angle position of a start end of the first sheet wound around the drum different between one and the other one of the pair of ply pieces.

14. The forming device for a green tire according to claim 1, further comprising:
a third servicer, which is disposed adjacent to the first servicer in an axial direction of the drum and sends out a strip-shaped third sheet for forming a plurality of the ply pieces; and
a third cutting portion that cuts the third sheet in order to separate one of the ply pieces, wherein
the first sheet and the third sheet differ in at least one of a width, a rubber material, and the number of cords, and
the control unit selectively moves the drum to one of the first servicer and the third servicer by the moving mechanism.

15. The forming device for a green tire according to claim 2, further comprising:
a third servicer, which is disposed adjacent to the first servicer in an axial direction of the drum and sends out a strip-shaped third sheet for forming a plurality of the ply pieces; and
a third cutting portion that cuts the third sheet in order to separate one of the ply pieces, wherein
the first sheet and the third sheet differ in at least one of a width, a rubber material, and the number of cords, and
the control unit selectively moves the drum to one of the first servicer and the third servicer by the moving mechanism.

16. The forming device for a green tire according to claim 5, further comprising:
a third servicer, which is disposed adjacent to the first servicer in an axial direction of the drum and sends out a strip-shaped third sheet for forming a plurality of the ply pieces; and
a third cutting portion that cuts the third sheet in order to separate one of the ply pieces, wherein
the first sheet and the third sheet differ in at least one of a width, a rubber material, and the number of cords, and
the control unit selectively moves the drum to one of the first servicer and the third servicer by the moving mechanism.

17. The forming device for a green tire according to claim 9, further comprising:
a third servicer, which is disposed adjacent to the first servicer in an axial direction of the drum and sends out a strip-shaped third sheet for forming a plurality of the ply pieces; and
a third cutting portion that cuts the third sheet in order to separate one of the ply pieces, wherein
the first sheet and the third sheet differ in at least one of a width, a rubber material, and the number of cords, and
the control unit selectively moves the drum to one of the first servicer and the third servicer by the moving mechanism.
